(19) United States
(12) Patent Application Publication
(10) Pub. No.: US 2026/0135183 A1
(43) Pub. Date: May 14, 2026

(54) Battery Cell Assembly and Battery Pack Including the Same

(71) Applicant: LG Energy Solution, Ltd., Seoul (KR)

(72) Inventors: Jun Ho Jang, Daejeon (KR); Dae Gil Kim, Daejeon (KR)

(73) Assignee: LG Energy Solution, Ltd., Seoul (KR)

(21) Appl. No.: 19/316,513

(22) Filed: Sep. 2, 2025

(30) Foreign Application Priority Data
Nov. 12, 2024 (KR) 10-2024-0159943

(51) Int. Cl. H01M 10/6551; H01M 10/613; H01M 10/653; H01M 10/6555; H01M 10/6567

(52) U.S. Cl. CPC H01M 10/6551; H01M 10/613; H01M 10/6555; H01M 10/653; H01M 10/6567

(57) ABSTRACT

The battery cell assembly of the present disclosure includes: a plurality of battery cells arranged in a first direction; and a first cooling fin, a second cooling fin, a third cooling fin, a fourth cooling fin, a fifth cooling fin, and a sixth cooling fin each disposed between the plurality of battery cells. The first and second cooling fins have the same shape and are arranged symmetrically, the third and fourth cooling fins have the same shape and are arranged symmetrically, and the fifth and sixth cooling fins have the same shape and are arranged symmetrically. Each of the third and fourth cooling fins has a shape different from that of the first and second cooling fins, and each of the fifth and sixth cooling fins has a shape different from that of the third and fourth cooling fins.

### CROSS-REFERENCE TO RELATED APPLICATIONS

This application is based on and claims priority from Korean Patent Application No. 10-2024-0159943, filed on Nov. 12, 2024, with the Korean Intellectual Property Office, the disclosure of which is incorporated herein in its entirety by reference.

### TECHNICAL FIELD

The present disclosure relates to a battery cell assembly and a battery pack including the same.

### BACKGROUND

Unlike primary batteries, secondary batteries are capable of repeated charging and discharging multiple times. For this reason and others, secondary batteries are being used widely as energy sources for various wireless devices such as handsets, laptops, and cordless vacuum cleaners. Recently, due to improvements in energy density and economies of scale, the manufacturing cost per unit capacity of secondary batteries has been dramatically reduced, and the driving range of battery electric vehicles (BEVs) has increased to a level comparable to that of fuel-powered vehicles, which has led to a shift in the primary application of secondary batteries from mobile devices to mobility.

In the current trend where secondary batteries for mobility are emphasized, the main directions in the technology development of secondary batteries are the improvement of energy density and the enhancement of safety, along with the reduction of production costs. Secondary batteries account for the largest portion of the manufacturing cost of BEVs. Therefore, the most critical factor in increasing the market share of BEVs compared to internal combustion engine vehicles is the production cost of secondary batteries. A reduction in production costs may be achieved by reducing the amount of raw materials, reducing the number of steps in the production process, and shortening the tact time. In the meantime, the safety of secondary batteries is critically important because it is directly related to the lives of passengers. One of the major challenges in enhancing the safety of secondary batteries is providing a cooling solution for the battery packs. For example, Korean Laid-Open Patent Publication No. 10-2020-0127748 discloses a battery case including a cooling unit configured to cool a battery module.

### SUMMARY

The present disclosure provides a battery cell assembly with enhanced cooling efficiency and a battery pack including the same.

Embodiments of the present disclosure provide a battery cell assembly. The battery cell assembly includes: a plurality of battery cells arranged in a first direction; and a first cooling fin, a second cooling fin, a third cooling fin, a fourth cooling fin, a fifth cooling fin, and a sixth cooling fin each disposed between the plurality of battery cells. The first and second cooling fins have the same shape and are arranged symmetrically, the third and fourth cooling fins have the same shape and are arranged symmetrically, and the fifth and sixth cooling fins have the same shape and are arranged symmetrically. Each of the third and fourth cooling fins has a shape different from that of the first and second cooling fins, and each of the fifth and sixth cooling fins has a shape different from that of the third and fourth cooling fins.

Each of the first and second cooling fins includes a first contact portion perpendicular to the first direction and a first heat dissipation portion perpendicular to the first contact portion.

Each of the third and fourth cooling fins includes a second contact portion perpendicular to the first direction, a second heat dissipation portion perpendicular to the second contact portion, and a first mounting portion between the second contact portion and the second heat dissipation portion.

The first mounting portion forms a stepped structure with the second heat dissipation portion.

The first mounting portion has a bent structure between the second contact portion and the second heat dissipation portion.

The first heat dissipation portion of the first cooling fin overlaps the first mounting portion of the third cooling fin adjacent to the first cooling fin in a third direction perpendicular to the first direction and a second direction in which the first cooling fin extends, and the first heat dissipation portion of the second cooling fin overlaps the first mounting portion of the fourth cooling fin adjacent to the second cooling fin in the third direction.

Each of the fifth and sixth cooling fins includes a third contact portion perpendicular to the first direction, a third heat dissipation portion perpendicular to the third contact portion, a second mounting portion between the third contact portion and the third heat dissipation portion, and first and second staggered portions connected to the third heat dissipation portion.

The second mounting portion has a bent structure between the third contact portion and the third heat dissipation portion.

The first and second staggered portions alternate in a second direction perpendicular to the first direction.

The first staggered portions are staggered from the second staggered portions in a third direction, and the third direction is perpendicular to each of the first direction and the second direction.

The position of each of the first staggered portions in the third direction differs from the position of each of the second staggered portions in the third direction.

Each of the second staggered portions is offset from the third heat dissipation portion in the third direction.

Each of the second staggered portions is at the same level as the second mounting portion in the third direction.

Each of the first staggered portions is coplanar with the third heat dissipation portion.

Other embodiments of the present disclosure provides a battery pack including at least one battery cell assembly described above.

According to the embodiments of the present disclosure, the rigidity of a battery pack may be ensured and the structure may be stabilized through cooling fins, so as to allow heat released from a plurality of battery cells to be discharged to cooling channels of a lid. As a result, the cooling efficiency of the battery pack may be enhanced.

The effects that may be obtained from the embodiments of the present disclosure are not limited to the effects mentioned above, and other effects not mentioned may be clearly derived and understood by those ordinarily skilled in the art to which the embodiments of the present disclosure belong from the following description. In other words, unintended effects resulting from the implementation of the embodiments of the present disclosure may also be derived by those ordinarily skill in the art from the embodiments of the present disclosure.

### BRIEF DESCRIPTION OF THE DRAWINGS

The following drawings attached hereto illustrate example embodiments of the present disclosure and, together with the detailed description to be described later, serve to further understand the technical idea of the present disclosure. Therefore, the present disclosure should not be construed as being limited to the matters illustrated in the drawings.

FIG. 1 is a perspective view illustrating a battery pack according to an embodiment of the present disclosure.

FIG. 2 is an exploded perspective view of the battery pack according to an embodiment of the present disclosure.

FIG. 3 is a perspective view of a battery cell assembly 120 according to an embodiment of the present disclosure.

FIG. 4 is a plan view of the battery cell assembly 120 according to an embodiment of the present disclosure.

FIG. 5 is a cross-sectional view taken along line 4I-4I′ of FIG. 4.

FIG. 6 is a cross-sectional view taken along line 4II-4II′ of FIG. 4.

FIG. 7 is a partial enlarged cross-sectional view of portion P1 of FIG. 5.

FIG. 8 is a partial enlarged cross-sectional view of portion P2 of FIG. 5.

FIG. 9 is a perspective view illustrating cooling fins 122A and 122B.

FIG. 10 is a perspective view illustrating cooling fins 123A and 123B.

FIG. 11 is a perspective view illustrating cooling fins 124A and 124B.

In some of the attached drawings, corresponding components are given the same reference numerals. Those skilled in the art would appreciate that the drawings depict elements simply and clearly and have not necessarily been drawn to scale. For example, in order to facilitate understanding of various embodiments, the dimensions of some elements illustrated in the drawings may be exaggerated compared to other elements. Additionally, elements of the known art that are useful or essential in commercially viable embodiments may often not be depicted so as not to interfere with the spirit of the various embodiments of the present disclosure.

### DETAILED DESCRIPTION

Hereinafter, embodiments of the present disclosure will be described with reference to the attached drawings. The terms and words used in the specification and claims should not be construed as being limited to their ordinary or dictionary meanings, but should be construed as meanings and concepts consistent with the technical idea of the present disclosure based on a principle that an inventor may appropriately define the concepts of terms in order to explain his or her invention in the best possible manner.

The embodiments in the specification and configurations illustrated in the drawings are merely provided as an example of the present disclosure, and do not represent all the technical ideas of the present disclosure. Therefore, it should be understood that there may be various equivalents and modifications that could replace them at the time of filing this application.

In describing the present disclosure, detailed explanations of related known functions and configurations will be omitted when it is determined that such detailed explanations may obscure the gist of the present disclosure.

The embodiments of the present disclosure are provided to more fully explain the present disclosure to those skilled in the art, and therefore, the shapes, sizes, and other aspects of the components shown in the drawings may be exaggerated, omitted, or schematically illustrated for the sake of clearer explanation. Therefore, the sizes or proportions of the components may not fully reflect their actual sizes or proportions.

Secondary batteries used as, for example, electric vehicle batteries, generate heat during repeated charging and discharging while in use. When the heat is not effectively managed, it may not only degrade battery performance but also shorten battery life and even lead to a fire. Accordingly, efficient thermal management of secondary batteries prevents or suppresses thermal runaway, which is a dangerous condition in which an increase in temperature causes uncontrollable heat generation and potential failure due to temperature rise, and, above all, improves the safety and reliability associated with the use of secondary batteries.

The present disclosure provides a battery pack that is enhanced in cooling efficiency and implements a more stable cooling system by introducing cooling fins to ensure the rigidity of the battery pack and stabilize the structure, so as to allow heat emitted from the plurality of battery cells to be released to cooling channels of a lid.

### First and Second Embodiments

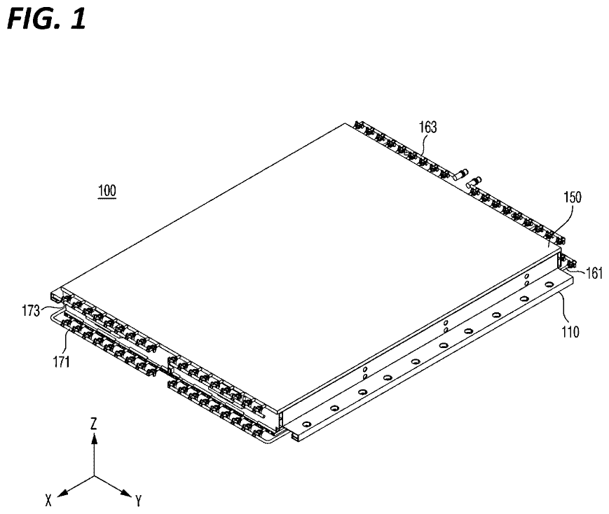

FIG. 1 is a perspective view illustrating a battery pack 100 according to an embodiment of the present disclosure.

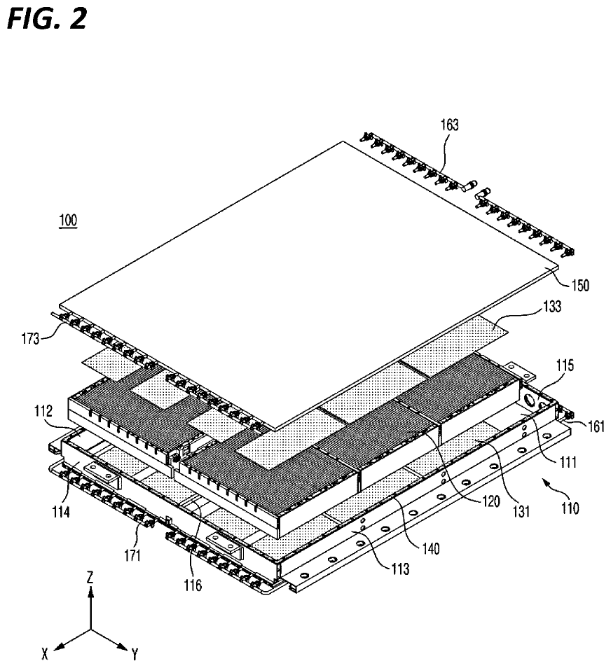

FIG. 2 is an exploded perspective view illustrating the battery pack 100 according to an embodiment of the present disclosure.

Referring to FIGS. 1 and 2, a battery pack 100 according to an embodiment of the present disclosure may include a housing 110, a plurality of battery cell assemblies 120, first thermal interface material (TIM) layers 131, second TIM layers 133, a gasket 140, a lid 150, a lower injection pipe 161, an upper injection pipe 163, a lower recovery pipe 171, and an upper recovery pipe 173. The battery pack 100 represents a final form of a battery system mounted on, for example, mobility.

The housing 110 may provide a space for accommodating the plurality of battery cell assemblies 120. According to an embodiment, the housing 110 may include a base plate 111, side walls 112, 113, 114, and 115, and a center beam 116.

Two directions substantially perpendicular to the mounting surface of the base plate 111 are defined as an X direction and a Y direction, respectively, and a direction substantially perpendicular to the XY plane of the base plate 111 is defined as a Z direction. The X, Y, and Z directions may be substantially perpendicular to one another. Unless otherwise specified, the definitions of these directions apply equally to the following drawings.

According to an embodiment, each of the base plate 111 and the side walls 112 and 113 may be provided through an extrusion process. In addition, the extrusion direction of each of the base plate 111 and the side walls 112 and 113 may be the X direction. For example, the YZ cross-sections of the base plate 111 and the side walls 112 and 113 may be consistent depending on the position in the X direction, except for deformation due to additional tooling. Here, the YZ cross-section may be substantially parallel to the Y and Z directions and substantially perpendicular to the X direction. The base plate 111 and the side walls 112 and 113 may be arranged in the Y direction. The side walls 114 and 115 may also be provided through an extrusion process.

According to an embodiment, the base plate 111 and the side walls 112 and 113 may be coupled by the friction stir welding. The base plate 111 may include a plurality of unit plates coupled by the friction stir welding.

According to an embodiment, the pack housing 110 may include a center beam 116. The center beam 116 may extend in the X direction. The center beam 116 may be positioned between the side walls 112 and 113. The center beam 116 may be included in a center plate disposed at the center of a plurality of unit plates coupled by friction stir welding. Accordingly, the center beam 116 may be formed together with the center plate in an extrusion process, and the center beam 116 may be a continuous element integrally formed with the center plate.

According to an embodiment, the base plate 111 may include a plurality of first cooling channels. The plurality of first cooling channels may provide passages for the movement of a coolant, such as water. The first cooling channels may be formed by an extrusion process. The first cooling channels may extend in the X direction. The first cooling channels may be spaced apart from each other in the Y direction.

The first cooling channels of the base plate 111 may be connected to the lower injection pipe 161 and the lower recovery pipe 171. A cooling fluid introduced through the lower injection pipe 161 may flow through the first cooling channels and may be recovered by the lower recovery pipe 171.

The plurality of battery cell assemblies 120 may be disposed and accommodated on the base plate 111 of the housing 110. The base plate 111 may support the battery cell assemblies 120. The side walls 112, 113, 114, and 115 may horizontally surround the battery cell assemblies 120.

According to an embodiment, first thermal interface material (TIM) layers 131 may be interposed between the plurality of battery cell assemblies 120 and the base plate 111. The first TIM layers 131 may include a resin composition. The first TIM layers 131 may be provided through an application process of thermal resin. The first TIM layers 131 may prevent or suppress the formation of an air layer between the base plate 111 and the battery cells 121, thereby promoting the cooling of the battery cell assemblies 120. The first TIM layers 131 may be in contact with the battery cells 121 of the battery cell assemblies 120 and the base plate 111.

According to an embodiment, the resin composition may be a room-temperature curable composition. For example, a curing reaction of the resin composition may be initiated and proceed at room temperature. The curing reaction of the resin composition may be accelerated at a temperature higher than room temperature. At a temperature higher than room temperature, the curing rate of the resin composition may be faster than the curing rate at room temperature. As a non-limiting example, a base resin in the resin composition may be any one of silicone resin, polyol resin, epoxy resin, or acrylic resin.

According to an embodiment, the center beam 116 may extend in the X direction. The center beam 116 may be positioned at a central portion of the base plate. The center beam 116 may isolate the battery cell assemblies 120 from each other. The center beam 116 may be positioned between the battery cell assemblies 120.

In this example, the battery cell assemblies 120 are arranged in two rows and three columns. Accordingly, the battery cell assemblies 120 may be said to be arranged in a 3-by-2 configuration. Based on the description provided herein, a person ordinarily skilled in the art may readily arrive at a battery pack including battery cell assemblies 120 arranged in an M-by-N configuration. Here, M and N are each arbitrary integers of 2 or more.

According to an embodiment, the lid 150 may be coupled to the side walls 112, 113, 114, and 115. The lid 150 may be fixed to the side walls 112, 113, 114, and 115 by mechanical elements such as bolts. The lid 150 may cover components disposed inside the battery pack 100, such as the battery cell assemblies 120 and electric components. A gasket 140 may be interposed between the lid 150 and the side walls 112, 113, 114, and 115. The gasket 140 may provide liquid-tight sealing to the battery pack 100.

According to an embodiment, the lid 150 may be provided by an extrusion process. The lid 150 may include a plurality of second cooling channels. The plurality of second cooling channels may provide passages for the movement of a coolant, such as water. According to an embodiment, the second cooling channels may be formed by an extrusion process. The second cooling channels may extend in the X direction. The second cooling channels may be spaced apart from each other in the Y direction.

The second cooling channels of the lid 150 may be connected to an upper injection pipe 163 and an upper recovery pipe 173. A cooling fluid introduced through the upper injection pipe 163 may flow through the second cooling channels and may be recovered by the upper recovery pipe 173.

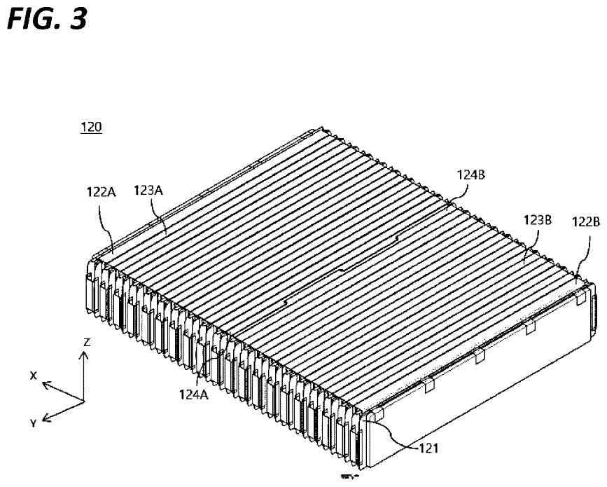

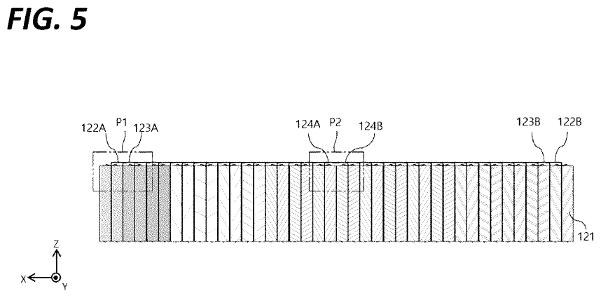

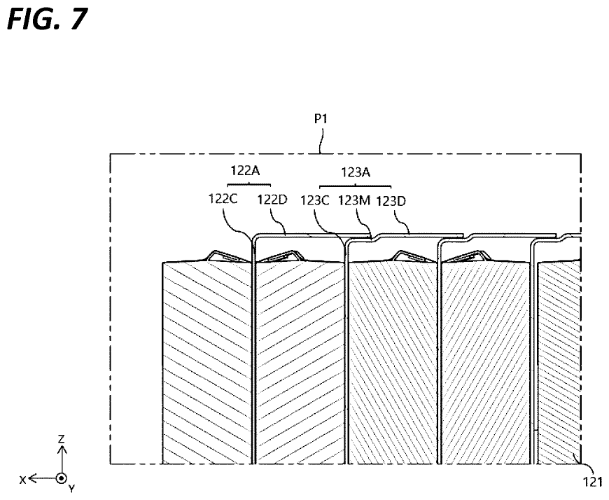

According to an embodiment, second TIM layers 133 may be interposed between the lid 150 and the plurality of battery cell assemblies 120. For example, the second TIM layers 133 may be thermal conduction pads. Each of the second TIM layers 133 may be spaced apart from the plurality of battery cells 121. Each of the second TIM layers 133 may be in contact with cooling fins 122A, 122B, 123A, 123B, 124A, and 124B (see FIG. 3). For example, each of the second TIM layers 133 may be in contact with heat dissipation portions 122D (see FIG. 7) of the cooling fins 122A, 122B, 123A, 123B, 124A, and 124B (see FIG. 3). Each of the second TIM layers 133 may also be in contact with the lid 150. The heat dissipation portion 122D (see FIG. 5) of each of the cooling fins 122A, 122B, 123A, 123B, 124A, and 124B (see FIG. 3) may be spaced apart from the lid 150 with the second TIM layers 133 interposed therebetween.

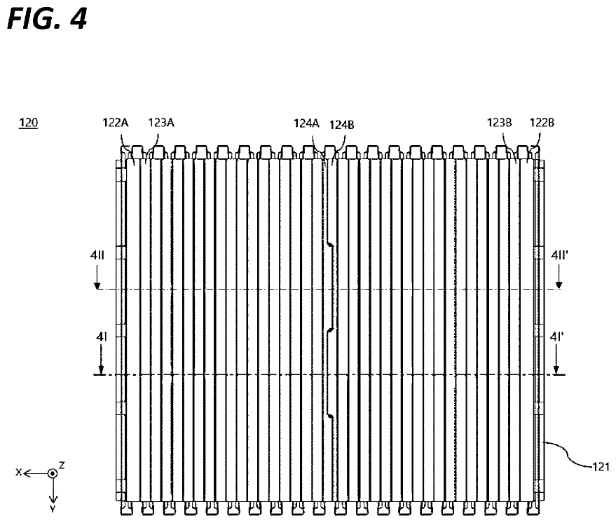

According to an embodiment, cooling fins 122A, 122B, 123A, 123B, 124A, and 124B (see FIG. 4) may be configured to be in contact with the plurality of battery cells 121 (see FIG. 4) and to cover terrace portions of the battery cells 121. Accordingly, the formation of air layers between the plurality of battery cells 121 (see FIG. 4) and the second TIM layers 133 may be prevented or suppressed due to the terrace portions of the battery cells 121, and the cooling efficiency of the battery pack 100 may be improved. Here, the terrace refers to a sealing portion of a case of each of the plurality of battery cells 121.

According to an embodiment, a lower portion of each of the plurality of battery cells 121 (e.g., a portion of each of the battery cells 121 adjacent to the base plate 111) is in direct contact with the first TIM layers 131, so that the formation of an air layer between the battery cells 121 and the base plate 111 may be prevented or suppressed, and the cooling efficiency of the battery pack 100 may be improved.

The battery pack 100 may further include exhaust devices coupled to the side wall 115. The exhaust devices may delay thermal propagation by discharging high-temperature gas and flame inside the battery pack 100 when a thermal runaway event occurs in the battery pack 100.

Here, thermal runaway of the battery cell assemblies 120 refers to a state in which a temperature change of the battery cell assemblies 120 further accelerates the temperature change itself, resulting in an uncontrollable positive feedback. The battery cell assemblies 120 in the thermal runaway state exhibit a rapid temperature increase and discharge a large amount of high-pressure gas and combustion residues.

The battery pack 100 may further include electrical components. The electrical components may include any electronic element required to operate the battery pack. The electrical components may be disposed on an electrical component mounting region (EMR).

The electrical components may include, for example, a battery management system (BMS). The BMS may be configured to perform monitoring, balancing, and control of the battery pack. Monitoring of the battery pack 100 may include measuring voltages and currents at specific nodes inside the battery cell assemblies 120 and measuring temperatures at predetermined positions inside the battery pack 100. The battery pack 100 may include measuring instruments configured to measure the voltages, currents, and temperatures described above.

Balancing of the battery pack 100 refers to an operation that reduces deviations among the battery cell assemblies 120. Control of the battery pack 100 includes preventing or suppressing the occurrence of over-charging, over-discharging, and over-current. Through the monitoring, balancing, and control, the battery pack 100 may operate under optimal conditions, thereby preventing or suppressing shortening of the lifespan of each of the battery cell assemblies 120.

The electrical components may further include, for example, a cooling device, a power relay assembly (PRA), and a safety plug. The cooling device may include a cooling fan. The cooling fan may prevent or suppress overheating of each of the battery cell assemblies 120 by circulating air inside the battery pack 100. The PRA may be configured to supply or cut off power from the high-voltage battery to an external load (e.g., a vehicle motor). The PRA may protect the battery cell assemblies 120 and an external load (e.g., a vehicle motor) by cutting off the power supply to the external load when an abnormal voltage, such as a voltage surge, occurs.

The battery pack 100 may further include a plurality of exhaust devices. The plurality of exhaust devices may be installed on one of the lid 150 and the side walls 112, 113, 114, and 115. The exhaust devices may provide a path for discharging high-temperature gas inside the battery pack 100 to the outside when a thermal runaway event occurs in some of the battery cell assemblies 120. Accordingly, thermal propagation may be delayed if necessary, and the safety of the battery pack 100 may be improved.

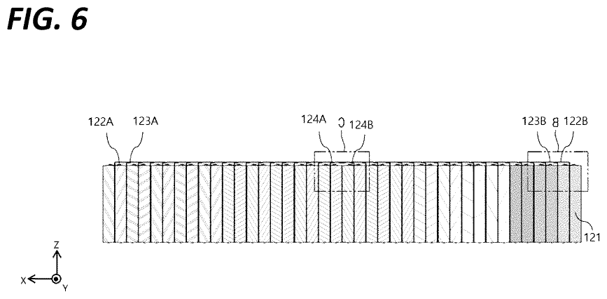

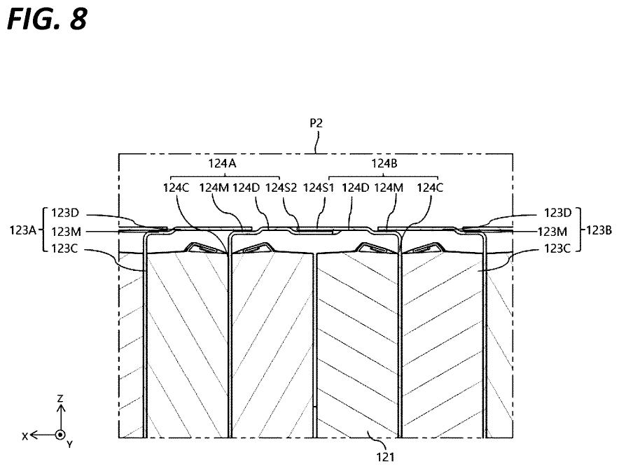

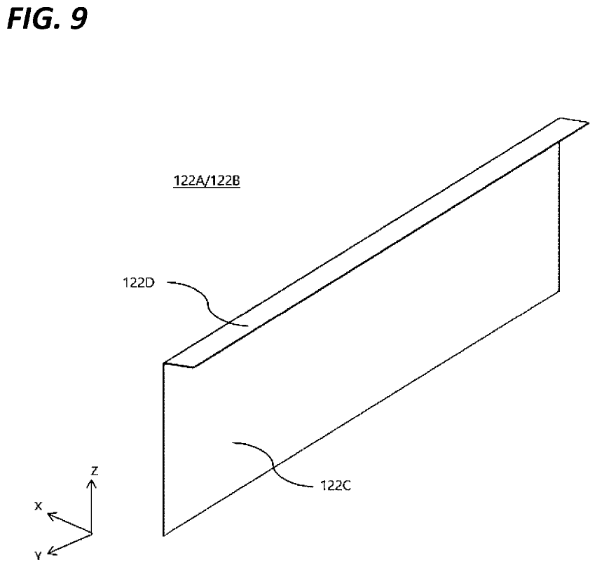

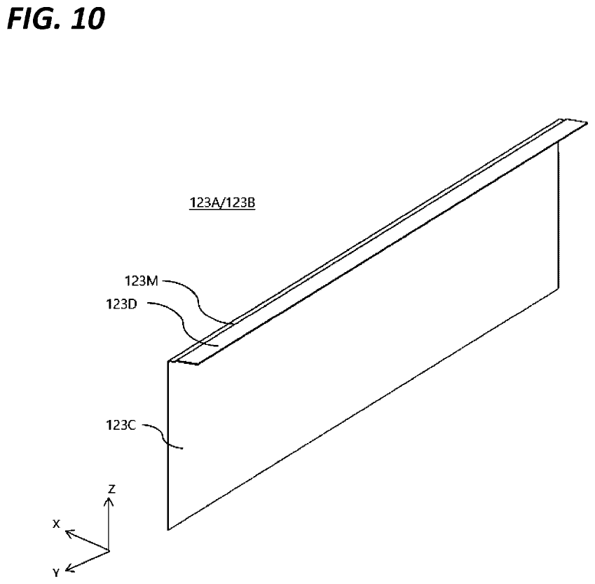

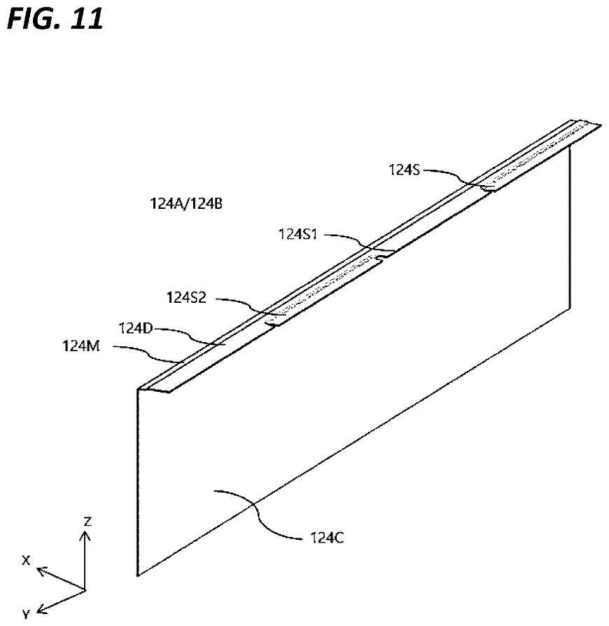

Referring to FIGS. 3 to 11, each of the battery cell assemblies 120 may include a plurality of battery cells 121 and a plurality of cooling fins 122A, 122B, 123A, 123B, 124A, and 124B.

The plurality of battery cells 121 may be arranged in the X direction. Each of the battery cells 121 may be a lithium-ion battery. Each of the battery cells 121 includes an electrode assembly, an electrolyte, and a case. Each of the plurality of battery cells 121 may be one of a cylindrical battery cell, a prismatic battery cell, or a pouch-type battery cell. The case of the cylindrical battery cell may be a cylindrical metal can. The electrode assembly of the cylindrical battery cell is housed in a cylindrical metal can. The case of the prismatic battery cell may be a prismatic metal case. The electrode assembly of the prismatic battery cell housed in a prismatic metal can. The case of the pouch-type battery cell may be a pouch sheet. The electrode assembly of the pouch-type battery cell is housed in a pouch case including an aluminum laminate sheet.

The electrode assembly may include a positive electrode, a negative electrode, and a separator interposed between the positive electrode and the negative electrode. The electrode assembly may be of either a jelly-roll type or a stacked type. The jelly-roll type electrode assembly may include a wound structure of the positive electrode, the negative electrode, and a separator interposed therebetween. The stacked type electrode assembly may include a plurality of positive electrodes, a plurality of negative electrodes, and a plurality of separators all of which are sequentially stacked, in which the separators are interposed the positive and negative electrodes.

The plurality of battery cells 121 may constitute a plurality of banks. Each of the banks may include one or more of the battery cells 121. The one or more battery cells 121 in each of the banks may be connected in parallel with each other. The banks may be connected in series with each other. The number of the banks connected in series and the number of battery cells 121 included in the plurality of banks may be determined according to the magnitude of voltage and current to be output from each of the battery cell assemblies 120.

Each of the cooling fins 122A, 122B, 123A, 123B, 124A, and 124B may be positioned between the battery cells 121. The cooling fins 122A, 122B, 123A, 123B, 124A, and 124B may alternate with the battery cells 121 in the X direction. One of the cooling fins 122A, 122B, 123A, 123B, 124A, and 124B may be interposed between two adjacent ones of the plurality of battery cells 121. One of the battery cells 121 may be interposed between two adjacent ones of the cooling fins 122A, 122B, 123A, 123B, 124A, and 124B.

Each of the cooling fins 122A, 122B, 123A, 123B, 124A, and 124B may extend in the Y direction. Each of the cooling fins 122A, 122B, 123A, 123B, 124A, and 124B may have high thermal conductivity. Each of the cooling fins 122A, 122B, 123A, 123B, 124A, and 124B may include a metal such as aluminum or stainless steel.

According to an embodiment, each of the cooling fins 122A and 122B may have a substantially Γ shape. The shape of the cooling fin 122A may be substantially the same as the shape of the cooling fin 122B. The cooling fin 122A may be arranged symmetrically with the cooling fin 122B. The cooling fin 122A and the cooling fin 122B may be symmetrical with respect to the YZ plane. Alternatively, the cooling fin 122A may be arranged in an opposite direction to the cooling fin 122B.

Each of the cooling fins 122A and 122B may include a contact portion 122C and a heat dissipation portion 122D connected to the contact portion 122C. The contact portion 122C may be substantially perpendicular to the X direction. Alternatively, the contact portion 122C may be inclined with respect to the X direction. The heat dissipation portion 122D may be substantially perpendicular to the Z direction. Alternatively, the heat dissipation portion 122D may be inclined with respect to the Z direction. The heat dissipation portion 122D may be substantially perpendicular to the contact portion 122C. The heat dissipation portion 122D may be inclined with respect to the contact portion 122C.

The contact portion 122C may face a corresponding one of the battery cells 121. The contact portion 122C may be in contact with a corresponding one of the battery cells 121. The contact portion 122C of each of the cooling fins 122A and 122B may be in contact with an outermost one of the battery cells 121. The heat dissipation portion 122D may face the lid 150. The heat dissipation portion 122D may also be in contact with the second TIM layers 133. Accordingly, heat transferred from the battery cell 121 to the heat dissipation portion 122D through the contact portion 122C may be released to the outside through the lid 150.

The cooling fins 123A and 123B may be positioned between the cooling fins 122A and 122B. Each of the cooling fins 123A and 123B may have a substantially Γ shape. The shape of each of the cooling fins 123A and 123B may differ from that of each of the cooling fins 122A and 122B. Alternatively, the shape of each of the cooling fins 123A may be substantially the same as the shape of each of the cooling fins 123B. Each of the cooling fins 123A may be arranged symmetrically with each of the cooling fins 123B. For example, each of the cooling fins 123A may be symmetrical with each of the cooling fins 123B with respect to the YZ plane. Each of the cooling fins 123A may also be arranged in an opposite direction to each of the cooling fins 123B.

Each of the cooling fins 123A and 123B may include a contact portion 123C, a mounting portion 123M, and a heat dissipation portion 123D. The contact portion 123C may be substantially perpendicular to the X direction. Alternatively, the contact portion 123C may be inclined with respect to the X direction.

The mounting portion 123M is formed, for example, through an additional bending process, such that a corner portion of the substantially Γ shape has a structure in which a heat dissipation portion (e.g., 122D) of an adjacent cooling fin may be seated. Through this, the cooling fins are seated on each other, providing a structure in which loads are distributed. The mounting portion 123M may be substantially perpendicular to the Z direction. Alternatively, the mounting portion 123M may be inclined with respect to the Z direction. The mounting portion 123M may be substantially perpendicular to the contact portion 123C. Alternatively, the mounting portion 123M may be inclined with respect to the contact portion 123C.

The heat dissipation portion 123D may be substantially perpendicular to the Z direction. Alternatively, the heat dissipation portion 123D may be inclined with respect to the Z direction. The heat dissipation portion 123D may be substantially perpendicular to the contact portion 123C. Alternatively, the heat dissipation portion 123D may be inclined with respect to the contact portion 123C.

According to an embodiment, the mounting portion 123M and the heat dissipation portion 123D may form a stepped structure. The mounting portion 123M may be formed between the contact portion 123C and the heat dissipation portion 123D. The mounting portion 123M may be connected to each of the contact portion 123C and the heat dissipation portion 123D.

The contact portion 123C may face a corresponding one of the battery cells 121. The contact portion 123C may be in contact with a corresponding one of the battery cells 121. The heat dissipation portion 123D may face the lid 150. The heat dissipation portion 123D may also be in contact with the second TIM layers 133. Accordingly, heat transferred from the battery cell 121 to the heat dissipation portion 123D through the contact portion 123C may be released to the outside through the lid 150.

The mounting portion 123M may face the heat dissipation portion 122D of the adjacent cooling fins 122A and 122B or the heat dissipation portion 123D of the adjacent cooling fins 123A and 123B. Alternatively, the mounting portion 123M may be in contact with the heat dissipation portion 122D of the adjacent cooling fins 122A and 122B or the heat dissipation portion 123D of the adjacent cooling fins 123A and 123B.

The heat dissipation portion 122D of the cooling fin 122A may be seated on the mounting portion 123M of the adjacent cooling fin 123A. The heat dissipation portion 122D of the cooling fin 122B may be seated on the mounting portion 123M of the adjacent cooling fin 123B.

The heat dissipation portion 123D of a preceding one of the cooling fins 123A may be seated on the mounting portion 123M of a subsequent one of the cooling fins 123A. The heat dissipation portion 123D of a preceding one of the cooling fins 123B may be seated on the mounting portion 123M of a subsequent one of the cooling fins 123B.

The cooling fins 124A and 124B may be positioned between the cooling fins 122A and 122B. The cooling fins 124A and 124B may be positioned between the cooling fins 123A and 123B. Each of the cooling fins 124A and 124B may have a substantially Γ shape. The shape of each of the cooling fins 124A and 124B may differ from that of each of the cooling fins 122A and 122B. The shape of each of the cooling fins 124A and 124B may differ from that of each of the cooling fins 123A and 123B. The shape of the cooling fin 124A may be substantially the same as the shape of the cooling fin 124B. The cooling fin 124A may be arranged symmetrically with the cooling fin 124B. The cooling fin 124A and the cooling fin 124B may be symmetrical with respect to the YZ plane. Alternatively, the cooling fin 124A may be arranged in an opposite direction to the cooling fin 124B.

Each of the cooling fins 124A and 124B may include a contact portion 124C, a mounting portion 124M, a heat dissipation portion 124D, and staggered portions 124S1 and 124S2. The contact portion 124C may be substantially perpendicular to the X direction. Alternatively, the contact portion 124C may be inclined with respect to the X direction.

The mounting portion 124M is formed, for example, through an additional bending process, such that a corner portion of the substantially Γ shape has a structure in which a heat dissipation portion (e.g., 123D) of an adjacent cooling fin may be seated. Through this, the cooling fins are seated on each other, providing a structure in which loads are distributed. The mounting portion 124M may be substantially perpendicular to the Z direction. Alternatively, the mounting portion 124M may be inclined with respect to the Z direction. The mounting portion 124M may be substantially perpendicular to the contact portion 124C. Alternatively, the mounting portion 124M may be inclined with respect to the contact portion 124C. The heat dissipation portion 124D may be substantially perpendicular to the Z direction. Alternatively, the heat dissipation portion 124D may be inclined with respect to the Z direction. The heat dissipation portion 124D may be substantially perpendicular to the contact portion 124C. Alternatively, the heat dissipation portion 124D may be inclined with respect to the contact portion 124C.

According to an embodiment, the mounting portion 124M and the heat dissipation portion 124D may form a stepped structure. The mounting portion 124M may be positioned between the contact portion 124C and the heat dissipation portion 124D. For example, the mounting portion 124M may be connected to each of the contact portion 124C and the heat dissipation portion 124D.

Each of the staggered portions 124S1 and 124S2 may be connected to the heat dissipation portion 124D. The staggered portions 124S1 and 124S2 may alternate with each other in the Y direction. For example, a staggered portion 124S2 may be positioned between the staggered portions 124S1. Alternatively, a staggered portion 124S1 may be positioned between the staggered portions 124S2.

The staggered portions 124S1 may be staggered from the staggered portions 124S2 in the Z direction. The position of each of the staggered portions 124S1 in the Z direction may differ from the position of each of the staggered portions 124S2 in the Z direction. Each of the staggered portions 124S1 may be spaced farther from the contact portion 124C in the Z direction than each of the staggered portions 124S2. Each of the staggered portions 124S1 may be spaced farther from the base plate 111 in the Z direction than each of the staggered portions 124S2. Alternatively, each of the staggered portions 124S1 may be closer to the lid 150 in the Z direction than each of the staggered portions 124S2.

Each of the staggered portions 124S1 may be coplanar with the heat dissipation portion 124D, although not limited thereto. For example, each of the staggered portions 124S2 may be offset in the Z direction by forming a step with the heat dissipation portion 124D. Each of the staggered portions 124S2 may be at the same level as the mounting portion 124M in the Z direction. For example, the position of each of the staggered portions 124S2 in the Z direction may be substantially the same as the position of the mounting portion 124M in the Z direction. Due to such staggered portions 124S1 and 124S2, rigidity is ensured and load is distributed, so as to enhance the binding force between the cooling fins.

The contact portion 124C may face a corresponding one of the battery cells 121. The contact portion 124C may be in contact with a corresponding one of the battery cells 121. The heat dissipation portion 124D may face the lid 150. The heat dissipation portion 124D may also be in contact with the second TIM layers 133. Accordingly, heat transferred from the battery cell 121 to the heat dissipation portion 124D through the contact portion 124C may be released to the outside through the lid 150.

The mounting portion 124M may face the heat dissipation portion 123D of the adjacent cooling fins 123A and 123B. Alternatively, the mounting portion 124M may be in contact with the heat dissipation portion 123D of the adjacent cooling fins 123A and 123B. The heat dissipation portion 123D of one of the cooling fins 123A may be seated on the mounting portion 124M of an adjacent cooling fin 124A. In addition, the heat dissipation portion 123D of one of the cooling fins 123B may be seated on the mounting portion 124M of an adjacent cooling fin 124B.

The cooling fin 124A may be fastened to the cooling fin 124B. Accordingly, the cooling fin 124A and the cooling fin 124B may form an interlocking structure. The staggered portions 124S1 of the cooling fin 124A may face the staggered portions 124S2 of the cooling fin 124B. The staggered portions 124S1 of the cooling fin 124A may overlap the staggered portions 124S2 of the cooling fin 124B in the Z direction. The staggered portions 124S1 of the cooling fin 124A may be in contact with the staggered portions 124S2 of the cooling fin 124B.

The staggered portions 124S2 of the cooling fin 124A may face the staggered portions 124S1 of the cooling fin 124B. The staggered portions 124S2 of the cooling fin 124A may overlap the staggered portions 124S1 of the cooling fin 124B in the Z direction. The staggered portions 124S2 of the cooling fin 124A may be in contact with the staggered portions 124S1 of the cooling fin 124B.

According to an embodiment, the respective heat dissipation portions 122D and 123D of the cooling fins 122A and 122B and the cooling fins 123A and 123B are seated on the corresponding mounting portions 123M and 124M of the cooling fins 123A and 123B and the cooling fins 124A and 124B, so that the structural stability of each of the battery cell assemblies 120 may be enhanced. Furthermore, due to the fastening of the cooling fin 124A and the cooling fin 124B, the structural stability of each of the battery cell assemblies 120 may be further enhanced. For example, the conventional cooling fin structure formed by simply arranging cooling fins having approximately the same Γ-shape in succession had limitations in ensuring sufficient rigidity, as the load thereof was not distributed when the structure was brought into contact with a thermal pad configured to cool the upper surfaces of battery cells. However, the cooling fins of the present disclosure, as described above, adopt an overlap structure implemented by, for example, a mounting portion, thereby securing sufficient rigidity while allowing the respective cooling fins to be seated with one another, which increases the binding force between the cooling fins and distributes force applied from the upper end.

Each of the plurality of battery cell assemblies 120 may further include first and second integrated circuit assemblies. The first integrated circuit assembly may include an insulating frame, an integrated circuit, busbars, and an insulating cover. The second integrated circuit assembly may include an insulating frame, an integrated circuit, and an insulating cover. The second integrated circuit assembly is generally similar to the first integrated circuit assembly except that it does not include the busbars.

The insulating frame may include an insulating material such as plastic. The insulating frame may cover the front of the plurality of battery cells 121. The insulating frame may support the integrated circuit, the busbars, and sensing plates.

The busbars may be shorted to the positive electrode leads of one or more battery cells 121 in the first bank and the negative electrode leads of one or more battery cells 121 in the last bank. The busbars may be welded to the positive electrode leads of one or more battery cells 121 in the first bank and the negative electrode leads of one or more battery cells 121 in the last bank. A resulting voltage of the plurality of battery cells 121 may be output through the busbars. The busbars may be fixed to the insulating frame.

The integrated circuit may be mounted on the insulating frame. The welded positive electrode leads and negative electrode leads may form nodes inside the battery cell assembly 120. The integrated circuit may be configured to measure voltages of the nodes.

The insulating cover may include an insulating material such as plastic. The insulating cover may be fitted to the insulating frame. The insulating cover may cover the integrated circuit, so that the electrical elements of the first integrated circuit assembly may be protected.

In the foregoing, the present disclosure has been described in detail with reference to the drawings and embodiments. However, the embodiments described in this specification and the configurations illustrated in the drawings are merely embodiments of the present disclosure, and do not represent all the technical ideas of the present disclosure. Therefore, it should be understood that, at the time of filing, there may be various equivalents and modifications that could serve as alternatives to the embodiments.

What is claimed is:

1. A battery cell assembly comprising:
a plurality of battery cells arranged in a first direction; and
a first cooling fin, a second cooling fin, a third cooling fin, a fourth cooling fin, a fifth cooling fin, and a sixth cooling fin each disposed between the plurality of battery cells,
wherein the first and second cooling fins have a same shape and are arranged symmetrically with respect to each other,
wherein the third and fourth cooling fins have a same shape and are arranged symmetrically with respect to each other,
wherein the fifth and sixth cooling fins have a same shape and are arranged symmetrically with respect to each other,
wherein each of the third and fourth cooling fins has a shape different from that of the first and second cooling fins, and
wherein each of the fifth and sixth cooling fins has a shape different from that of the third and fourth cooling fins.

2. The battery cell assembly according to claim 1, wherein each of the first and second cooling fins includes a first contact portion perpendicular to the first direction and a first heat dissipation portion perpendicular to the first contact portion.

3. The battery cell assembly according to claim 2, wherein each of the third and fourth cooling fins includes a second contact portion perpendicular to the first direction, a second heat dissipation portion perpendicular to the second contact portion, and a first mounting portion between the second contact portion and the second heat dissipation portion.

4. The battery cell assembly according to claim 3, wherein the first mounting portion forms a stepped structure with the second heat dissipation portion.

5. The battery cell assembly according to claim 3, wherein the first heat dissipation portion of the first cooling fin overlaps the first mounting portion of the third cooling fin adjacent to the first cooling fin in a third direction perpendicular to the first direction and a second direction in which the first cooling fin extends, and
wherein the first heat dissipation portion of the second cooling fin overlaps the first mounting portion of the fourth cooling fin adjacent to the second cooling fin in the third direction.

6. The battery cell assembly according to claim 3, wherein each of the fifth and sixth cooling fins includes a third contact portion perpendicular to the first direction, a third heat dissipation portion perpendicular to the third contact portion, a second mounting portion between the third contact portion and the third heat dissipation portion, and first and second staggered portions connected to the third heat dissipation portion.

7. The battery cell assembly according to claim 6, wherein the first and second staggered portions alternate in a second direction perpendicular to the first direction.

8. The battery cell assembly according to claim 7, wherein the first staggered portions are staggered from the second staggered portions in a third direction, and
wherein the third direction is perpendicular to each of the first direction and the second direction.

9. The battery cell assembly according to claim 8, wherein a position of each of the first staggered portions in the third direction differs from a position of each of the second staggered portions in the third direction.

10. The battery cell assembly according to claim 8, wherein each of the second staggered portions is offset from the third heat dissipation portion in the third direction.

11. The battery cell assembly according to claim 8, wherein each of the second staggered portions is at a same level as the second mounting portion in the third direction.

12. The battery cell assembly according to claim 6, wherein each of the first staggered portions is coplanar with the third heat dissipation portion.

13. The battery cell assembly according to claim 3, wherein the first mounting portion has a bent structure between the second contact portion and the second heat dissipation portion.

14. The battery cell assembly according to claim 6, wherein the second mounting portion has a bent structure between the third contact portion and the third heat dissipation portion.

15. A battery pack comprising at least one battery cell assembly according to claim 1.
